(19) United States
(12) Patent Application Publication
(10) Pub. No.: US 2019/0064515 A1
(43) Pub. Date: Feb. 28, 2019

(54) DISPLAY DEVICE AND ELECTRONIC APPARATUS USING THE SAME

(71) Applicant: Innolux Corporation, Miao-Li County (TW)

(72) Inventors: Chung-Kuang WEI, Miao-Li County (TW); Jian-Cheng CHEN, Miao-Li County (TW); Li-Wei MAO, Miao-Li County (TW); Chih-Yung HSIEH, Miao-Li County (TW); Toshihiko ARAKI, Miao-Li County (TW); Wai-Lon CHAN, Miao-Li County (TW)

(21) Appl. No.: 16/049,917

(22) Filed: Jul. 31, 2018

Related U.S. Application Data
(60) Provisional application No. 62/551,824, filed on Aug. 30, 2017.

(30) Foreign Application Priority Data
Feb. 5, 2018 (CN) 201810113949.0

(51) Int. Cl. G02B 27/01; G02B 27/22; G02F 1/1335

(52) U.S. Cl. CPC G02B 27/0101; G02B 27/2214; G02F 1/133512; G02F 1/133514; G02B 2027/0134; G02F 1/133606; G02B 2027/0118; G02B 2027/0127; G02F 1/133603

(57) ABSTRACT

A display device is provided. The display device includes a display panel and a backlight module. The backlight module is disposed correspondingly to the display panel. The display panel has a first light-emitting area including a first sub-pixel and a second sub-pixel arranged adjacent to the first sub-pixel. The backlight module emits light, and the light has a first spectrum after passing through the first sub-pixel and a second spectrum after passing through the second sub-pixel, respectively. A peak of the first spectrum corresponds to a first wavelength, a peak of the second spectrum corresponds to a second wavelength, and a difference between the first wavelength and the second wavelength is less than 5 nm.

This application claims the benefits of U.S. provisional application No. 62/551,824, filed Aug. 30, 2017 and People's Republic of China application Serial No. 201810113949.0, filed Feb. 5, 2018, the subject matters of which are incorporated herein by references.

### BACKGROUND

### Technical Field

The disclosure relates to a display device, and more particularly to a display device capable of adjusting the colors of the displayed images.

### Description of the Related Art

Traditionally, vehicle drivers need to look down for obtaining the driving information on the display screen. It is easy to distract the driving attention. Accordingly, integrating the technique of augmenting reality into the human-machine interaction interface of the vehicle to form a head-up display (HUD) has become the current research and development trend between the display companies.

However, the head-up displays (HUD) for cars or other displays for cars require higher brightness or saturation than ordinary displays due to bright natural light in the outdoor environment, it consumes more energy. Therefore, how to improve the brightness and saturation of the display device and/or reduce the power consumption is one of the development priorities.

### SUMMARY

The disclosure is related to a display device. According to the embodiments of the present disclosure, at least two sub-pixels of a single light-emitting area emit light of the same color, thereby significantly increasing the brightness conversion rate of the light from the display device. Thus, the design of the embodiment enables the display device to present predetermined images, and greatly reduces the power consumption of the display device.

According to one embodiment of the present disclosure, a display device is provided. The display device includes a display panel and a backlight module. The backlight module is disposed correspondingly to the display panel. The display panel has a first light-emitting area including a first sub-pixel and a second sub-pixel arranged adjacent to the first sub-pixel. The backlight module emits light, and the light has a first spectrum after passing through the first sub-pixel and a second spectrum after passing through the second sub-pixel, respectively. A peak of the first spectrum corresponds to a first wavelength, a peak of the second spectrum corresponds to a second wavelength, and a difference between the first wavelength and the second wavelength is less than 5 nm.

According to one application of the present disclosure, an electronic apparatus is provided, comprising the display device as described above, and an enlarging projection optics, disposed correspondingly to a displaying surface of the display device.

The disclosure will become apparent from the following detailed description of the preferred but non-limiting embodiments. The following description is made with reference to the accompanying drawings.

### BRIEF DESCRIPTION OF THE DRAWINGS

FIG. 1 schematically illustrates a display device according to one embodiment of the disclosure.

FIG. 1A is a top view of a backlight module according to one embodiment of the disclosure.

FIG. 1B is a top view of another backlight module according to one embodiment of the disclosure.

FIG. 2 depicts light spectra of a display device according to one embodiment of the disclosure.

FIG. 3A-FIG. 3I schematically illustrate several display devices according to some of the embodiments of the disclosure.

FIG. 4A illustrates a predetermined display pattern according to one embodiment of the disclosure.

FIG. 4B illustrates an arrangement of the light-emitting areas and the opaque areas according to one embodiment of the disclosure.

FIG. 5A is an illustration of a display device according to one embodiment of the disclosure applied to augmented reality.

FIG. 5B is another illustration of a display device according to one embodiment of the disclosure applied to augmented reality.

### DETAILED DESCRIPTION

According to the embodiments of the present disclosure, a display device is provided, wherein at least two sub-pixels of a single light-emitting area emit light of the same color, thereby significantly increasing the brightness conversion rate of the light from the display device, and greatly decreasing the initial brightness of the backlight module. Thus, the design of the embodiment not only enables the display device to present predetermined images, but also significantly reduces the power consumption of the display device.

Several embodiments are described in details with reference to the accompanying drawings. It is noted that the details of the structures and procedures of the embodiments are provided for exemplification, not limitation to the present disclosure. Also, the identical and/or similar elements of the embodiments are designated with the same and/or similar reference numerals. Further, the accompany drawings are simplified for clear illustrations of the embodiment; sizes and proportions in the drawings are not directly proportional to actual products, and shall not be construed as limitations to the present disclosure. Modifications and variations can be made without departing from the spirit of the disclosure to meet the requirements of the practical applications. Moreover, when a first material layer formed “on” a second material layer or a substrate is described in the embodiments, it includes the condition of the first material layer “directly” or “indirectly” formed on the second material layer or the substrate. That is, one or more material layers could be disposed between the first material layer and the second material layer/the substrate. When a first material layer “connects” or “contacts” a second material layer or a substrate has been described in the embodiments, it includes the condition of the first material layer “directly connects/contacts” or “indirectly connects/contacts” the second material layer or the substrate. That is, one or more material layers could be disposed between the first material layer and the second material layer/the substrate. Additionally, use of ordinal terms such as “first”, “second”, “third”, etc., in the specification and claims to modify an element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

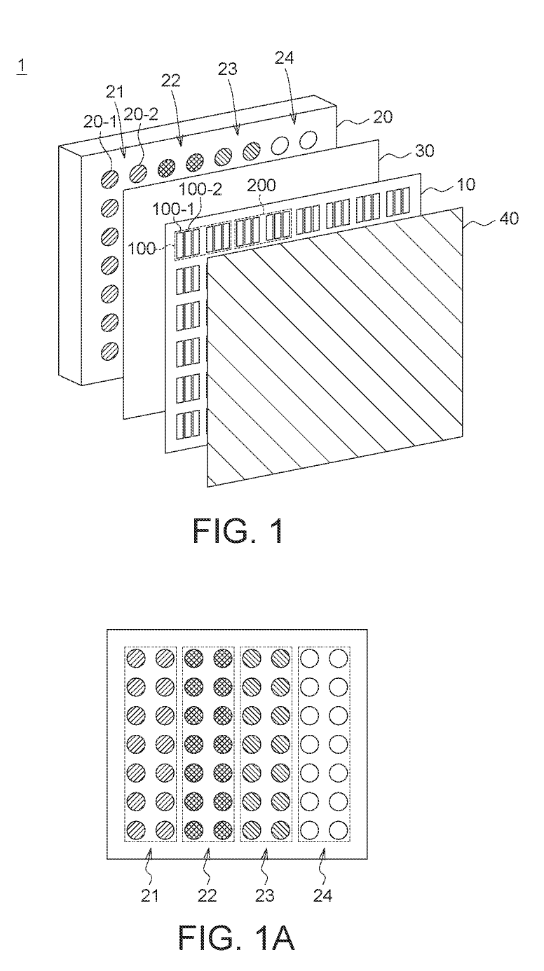

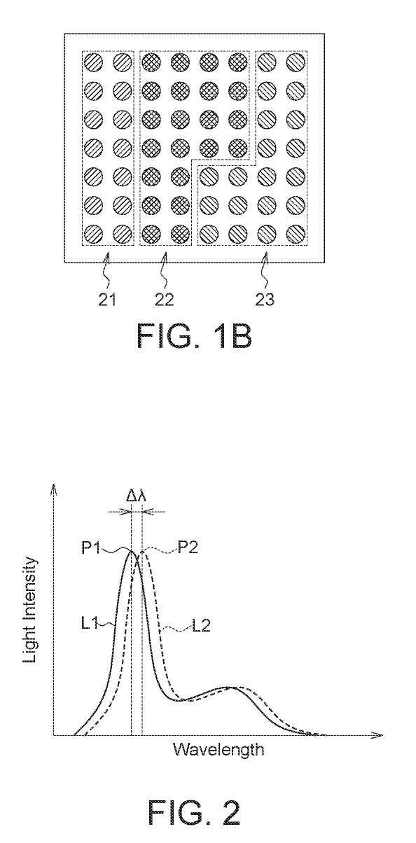

FIG. 1 schematically illustrates a display device according to one embodiment of the disclosure. FIG. 1A is a top view of a backlight module according to one embodiment of the disclosure. FIG. 1B is a top view of another backlight module according to one embodiment of the disclosure. FIG. 2 depicts light spectra of a display device according to one embodiment of the disclosure. As shown in FIG. 1 and FIG. 2, a display device 1 includes a display panel 10 and a backlight module 20 disposed opposite to the display panel 10. The display panel 10 has a first light-emitting area 100, and the first light-emitting area 100 includes a first sub-pixel 100-1 and a second sub-pixel 100-2 arranged adjacent to the first sub-pixel 100-1. The backlight module 20 emits light, and the light has a first spectrum L1 after passing through the first sub-pixel 100-1, and has a second spectrum L2 after passing through the second sub-pixel 100-2, wherein a peak P1 of the first spectrum L1 corresponds to a first wavelength, a peak P2 of the second spectrum L2 corresponds to a second wavelength, and a difference Δλ between the first wavelength and the second wavelength is less than 5 nm.

As shown in FIG. 2, one light spectrum may have multiple peaks. The peak as described herein is referred to the peak corresponding to the maximum light intensity. Although a white light spectrum of FIG. 2 is exemplified, other examples such as red-colored light source of the backlight module are also applicable, wherein a peak corresponding to the maximum light intensity in the light spectrum would be located at a red-light region; for example, the wavelength of the peak corresponding to the maximum light intensity is 650 nm.

According to the embodiment of the disclosure, the difference Δλ between the first wavelength and the second wavelength is less than 5 nm. That is, the first wavelength is substantially identical to the second wavelength. Therefore, the light emitted from the first sub-pixel 100-1 and the light emitted from the second sub-pixel 100-2 have substantially the same color.

In the embodiment, the first sub-pixel 100-1 is disposed adjacent to the second sub-pixel 100-2, and the first sub-pixel 100-1 and the second sub-pixel 100-2 are parts of a pixel, as shown in FIG. 1. In other words, adjacent sub-pixels of one pixel emit light having substantially the same color.

In the embodiment, the first light-emitting area 100 may include several sub-pixels, such as including at least two sub-pixels 100-1 and 100-2. As shown in FIG. 1, the first light-emitting area 100 includes six sub-pixels (equivalent to two pixels), but the disclosure is not limited thereto. According to the embodiment of the disclosure, the difference of the spectral wavelengths of the peaks between the light emitted from any two of the sub-pixels in a single light-emitting area (e.g. the first light-emitting area 100) is less than 5 nm; that is, all of the sub-pixels in a single light-emitting area (e.g. the first light-emitting area 100) emit light with substantially the same color.

According to the embodiment, by providing the design that at least two of sub-pixels in a single light-emitting area (e.g. the first light-emitting area 100) emit light having substantially the same color, the brightness conversion rate of the light emitted by the display device can be significantly increased, and the initial brightness of the backlight module can be greatly decreased, thereby enabling the display device to present predetermined images, and greatly reducing the power consumption of the backlight module.

In the embodiment, the backlight module 20 comprises a first backlight source 20-1 and a second backlight source 20-2, as shown in FIG. 1. The first backlight source 20-1 and the second backlight source 20-2 are disposed correspondingly to the first light-emitting area 100, and the first backlight source 20-1 and the second backlight source 20-2 both emit light of the same color. For example, the first backlight source 20-1 and the second backlight source 20-2 as shown in FIG. 1 emit red light. In another embodiment, the first light-emitting area 100 may include more pixels and more sub-pixels; for example, the first light-emitting area 100 may include three or more pixels, or include six or more sub-pixels. The numbers of the pixels and sub-pixels in the second light-emitting area 200 can be adjusted depending on actual needs of the applications. Different light-emitting areas may have sub-pixels with different sizes and different numbers of sub-pixels, determined based on the designs.

As shown in FIG. 1, the display device 1 further comprises an optical sheet 30 disposed between the display panel 10 and the backlight module 20. In some of the embodiments, the optical sheet 30 can include at least one of a brightness enhancement film, a reflective brightness enhancement film and a diffusion film. The brightness enhancement film can be used to collect the light, the reflective brightness enhancement film is capable of increasing the light efficiency, and the diffusion film is used for improving the uniformity of light intensity.

As shown in FIG. 1, the display device 1 further comprises a lenticular sheet 40 disposed on the display panel 10. The lenticular sheet 40 is used to form a three-dimensional (3D) image or enhance the depth of the image. Alternatively, metal diffraction gratings or white-photoresist diffraction gratings can be selectively disposed between the display panel 10 and the backlight module 20 to form a 3D image or enhance the depth of the displayed image.

In some of the embodiments, the backlight module 20 may include several backlight areas, such as a first backlight area 21 and a second backlight area 22, wherein the first backlight area 21 and the second backlight area 22 emit light of different colors.

Take the backlight module in FIG. 1A as an example (FIG. 1A is a top view of a backlight module 20 in FIG. 1), the backlight module 20 of the display device 1 at least includes a first backlight area 21 and a second backlight area 22, wherein several light emitting diodes (LEDs) such as red LEDs and green LEDs are disposed in the first backlight area 21 and the second backlight area 22, respectively. Thus, the first backlight area 21 emits red light, and the second backlight area 22 emits green light. As shown in FIG. 1A, the backlight module 20 of the display device 1 further includes a third backlight area 23 and/or a fourth backlight area 24, wherein several light emitting diodes (LEDs) such as blue LEDs are disposed in the third backlight area 23, and several LEDs such as yellow LEDs are disposed in the fourth backlight area 24. Thus, the third backlight area 23 emits blue light, and the fourth backlight area 22 emits yellow light.

Furthermore, take the backlight module in FIG. 1B as another example (FIG. 1B is a top view of another backlight module, which is different from the backlight module shown in FIG. 1A), the backlight module 20 in FIG. 1B includes a first backlight area 21, a second backlight area 22 and a third backlight area 23, wherein several light emitting diodes (LEDs) such as red LEDs are disposed in the first backlight area 21, several LEDs such as green LEDs are disposed in the second backlight area 22, and several LEDs such as blue LEDs are disposed in the third backlight area 23. Thus, the first backlight area 21 emits red light, the second backlight area 22 emits green light, and the third backlight area 23 emits blue light.

Accordingly, in some of the embodiments, the backlight module 20 of the display device can be designed to provide different backlight areas for emitting light of different colors. However, the colors of the light emitted from the backlight module, the number of the backlight areas, and the patterns of the backlight areas of the backlight module in the embodiments are provided for illustration, not for limiting the scope of the disclosure.

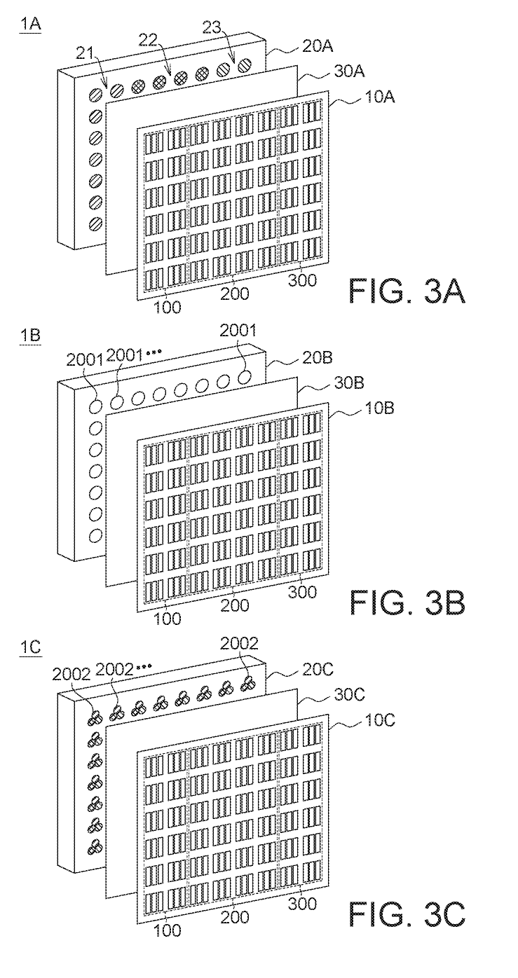

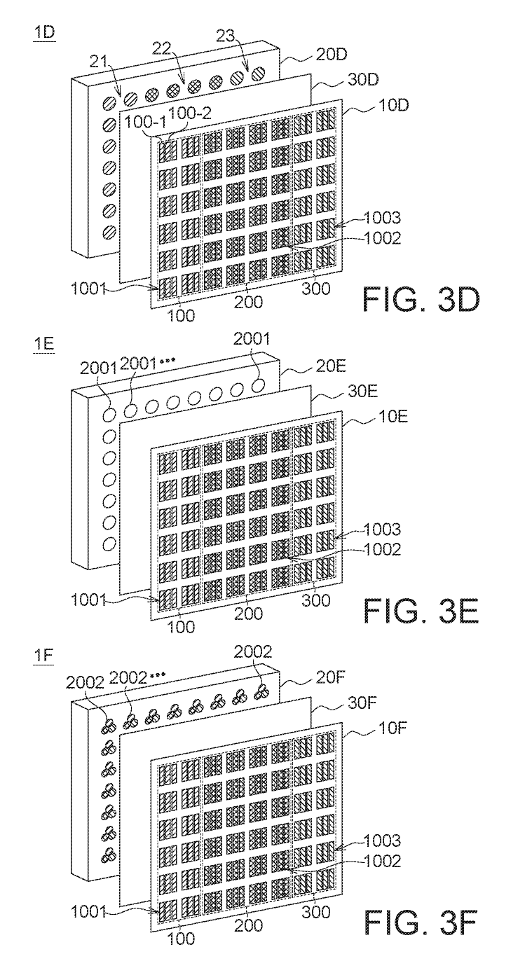

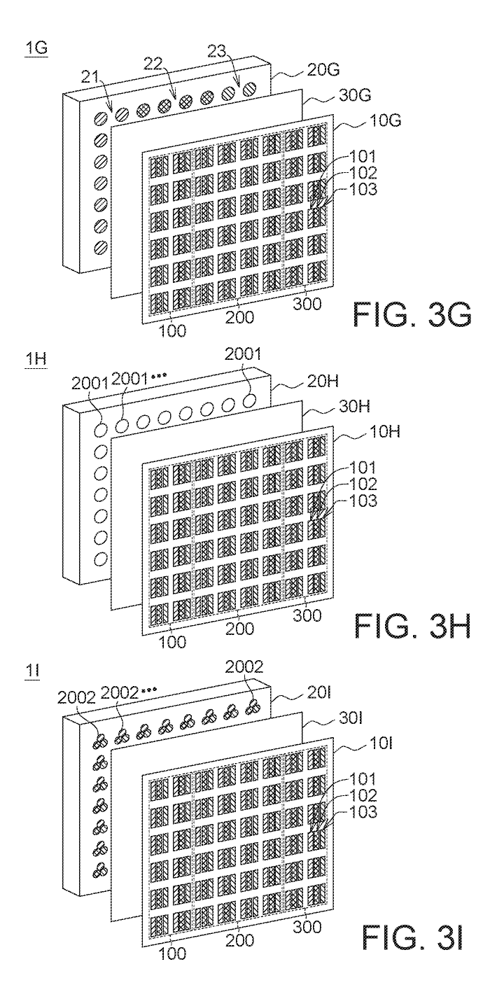

FIG. 3A-FIG. 3I schematically illustrate several display devices according to some of the embodiments of the disclosure. The identical and/or similar elements of those embodiments below and the forgoing embodiment (i.e. FIG. 1, FIG. 1A and FIG. 1B) are designated with the same and/or similar reference numerals. Also, please refer to the related descriptions for the details of those identical and/or similar elements above, and the contents are not redundantly repeated.

In some of the embodiments, the display panel further has a second light-emitting area 200, as shown in FIG. 1 and FIG. 3A-FIG. 3I, wherein the second light-emitting area 200 and the first light-emitting area 100 can emit light of the same color or different colors. The display panel can further has a third light-emitting area 300, wherein the light emitted from the third light-emitting area 300 and the second light-emitting area 200 and/or the first light-emitting area 100 can have the same color or different colors. As shown in FIG. 3A-FIG. 3I, one of the first light-emitting area 100 and the third light-emitting area 300 includes 36 sub-pixels (i.e. 3 (sub-pixels per pixel)×6 (pixels per column)×2 (columns)), and the second light-emitting area 200 includes 72 sub-pixels. In this embodiment, the size and shape of one of light-emitting area can be adjusted depending on actual needs of the applications, and the disclosure has no particular limitation thereto.

In some of the embodiments, the backlight module may include several backlight areas as shown in FIG. 1A or FIG. 1B. For example, as shown in FIG. 3A, FIG. 3D and FIG. 3G, the backlight modules 20A, 20D and 20G of the display devices 1A, 1D and 1G include the first backlight area 21, the second backlight area 22 and the third backlight area 23. Several LEDs such as red LEDs are disposed in the first backlight area 21, several LEDs such as green LEDs are disposed in the second backlight area 22, and several LEDs such as blue LEDs are disposed in the third backlight area 23. Thus, the first backlight area 21 emits red light, the second backlight area 22 emits green light, and the third backlight area 23 emits blue light. Accordingly, the color distributions of the display images on the display device are determined by the design of the separating areas of the backlight modules 20A, 20D and 20G, and the patterns and brightness of the display images are determined by the display panel. In this embodiment, the sizes and shapes of the separating areas of the backlight modules 20A, 20D and 20G can be adjusted depending on actual needs of the applications, and the disclosure has no particular limitation thereto.

In some of the embodiments, the backlight module may include several backlight sources emitting light of the same color, such as white light emitting diodes 2001 or red light emitting diodes. The backlight modules 20B, 20E and 20H of the display devices 1B, 1E and 1H include several white light emitting diodes, so that all of the backlight modules 20B, 20E and 20H of the display devices 1B, 1E and 1H emit white light. Compared to a single backlight source having LEDs emitting light of three different colors and those LEDs of three different colors being driven individually, the backlight sources of the backlight modules 20B, 20E and 20H merely includes the white light emitting diodes; that is, the power for driving the white LEDs of the latter backlights is merely one-third of the power for driving the colored LEDs of the former backlights.

In some of the embodiments, the backlight module can include several RGB LED backlight sources 2002 (i.e. LEDs emitting red light, green light and blue light). For example, at least one of the backlight sources includes one red LED, one green LED and one blue LED. For example, as shown in FIG. 3C, FIG. 3F and FIG. 3I, at least one of the backlight modules 20C, 20F and 20I of the display devices 1C, 1F and 1I comprises several RGB LED backlight sources 2002, so that the color of light emitted from one of the backlight sources in the backlight modules 20C, 20F and 20I of the display devices 1C, 1F and 1I can be controlled independently.

In some of the embodiments, there is no color filter layer contained in the display panel 10; therefore, the colors displayed by the sub-pixels of the display panel 10 are determined by the design of the backlight sources of the backlight module 20. For example, the display panels 10A, 10B and 10C of the display devices 1A, 1B and 1C have been constructed without disposing any color filter layer, but adjustment of gray scales of the image displayed on the display panel is still implementable.

In some of the embodiments, the first sub-pixel 100-1 and the second sub-pixel 100-2 disposed in the first light-emitting area 100 and arranged adjacently may have the same color, wherein “the same color” means that the difference of the spectral wavelengths at the peaks between the light passing the portions of the color filter layer related to the first and second sub-pixels is less than 5 nm. For example, a display panel may comprise a color filter layer, wherein a portion of the color filter layer corresponding to the first sub-pixel 100-1 and another portion of the color filter layer corresponding to the second sub-pixel 100-2 have the same color. For example, as shown in FIG. 3D, FIG. 3E and FIG. 3F, in the first light-emitting areas 100 of the display panels 10D, 10E and 10F of the display devices 1D, 1E and 1F, a portion of the color filter layer corresponding to the first sub-pixel 100-1 and another portion of the color filter layer corresponding to the second sub-pixel 100-2 have red color; that is, the difference of the spectral wavelengths at the peaks between the light passing the portions of the red color filter layer related to the first and second sub-pixels is less than 5 nm. Also, the color filter layer in the second light-emitting areas 200 can be a blue color filter layer, and the color filter layer in the third light-emitting areas 300 can be a green color filter layer.

In some of the embodiments, the display panel 10 can comprise a color filter layer, and the color filter layer may have a first colored block (bar) and a second colored block (bar), wherein the first colored block (bar) is disposed correspondingly to the first light-emitting area 100, and the second colored block (bar) is disposed correspondingly to the second light-emitting area 200. Also, several first colored blocks (/bars) disposed correspondingly to different sub-pixels may have different colors, and several second colored blocks (bars) disposed correspondingly to different sub-pixels may have different colors. With the color filter layer of the display panel and the grayscales values determined by the display panel, the first light-emitting area 100 and the second light-emitting area 200 can emit different light colors. Please see the display panels 10G, 10H and 10I of the display devices 1G, 1H and 1I, as shown in FIG. 3G, FIG. 3H and FIG. 3I.

Thus, as shown in FIG. 3A, the backlight module 20 of the display device 1A can be designed to provide several backlight areas for emitting light of different colors, so that the color display effect of the display device 1A is determined according to the design of the backlight areas. In one embodiment, the display panel adopts no color filter layer, and the backlight module 20A has several backlight areas, wherein the first light-emitting area 100 corresponds to the first backlight area 21, the second light-emitting area 200 corresponds to the second backlight area 22. Since the first backlight area 21 and the second backlight area 22 emit the light of different colors, the light from the first light-emitting area 100 and the second light-emitting area 200 have different colors.

As shown in FIG. 3B, the backlight module 20B of the display device 1B has the backlight sources emitting the same color, and a grayscale image is displayed in accordance with the color of the backlight sources. For example, the display panel 10B does not include a color filter layer, and the backlight module 20B includes several white light emitting diodes and emits white light, so that the first light-emitting area 100 and the second light-emitting area 200 emit the light of the same color.

As shown in FIG. 3C, the display panel 10C does not include a color filter layer, and the backlight module 20C of the display device 1C includes several RGB LED backlight sources 2002. Accordingly, the display device 1C is capable of showing images with more delicate colors and versatile patterns in accordance with the colors provided by the backlight sources of the backlight module 20C.

In other examples as shown in FIG. 3D, FIG. 3E and FIG. 3F, the color filter layer includes several first colored blocks (bars) 1001, second colored blocks (bars) 1002 and third colored blocks (bars) 1003, wherein the first colored blocks 1001, the second colored blocks 1002 and the third colored blocks 1003 are disposed correspondingly to the first light-emitting area 100, the second light-emitting area 200 and the third light-emitting area 300, respectively. In the embodiment, the first colored blocks 1001 have red color, the second colored blocks 1002 have green color, and the third colored blocks 1003 have blue color; therefore, the first light-emitting area 100, the second light-emitting area 200 and the third light-emitting area 300 emit lights of different colors. In another embodiment, the color filter layer may also include quantum dots for color conversion of the light, so that the color of the incident light passing through the color filter layer is converted into different colors of the emergent light.

As shown in FIG. 3D, the backlight module 20D of the display device 1D can be designed to provide several backlight areas for emitting light of different colors. The color filter layer of the display device 1D includes several first colored blocks (bars) 1001, second colored blocks (bars) 1002 and third colored blocks (bars) 1003, and the backlight module 20D has several backlight areas. The first light-emitting area 100 is disposed correspondingly to the first backlight area 21, the second light-emitting area 200 is disposed correspondingly to the second backlight area 22, and the third light-emitting area 300 is disposed correspondingly to the third backlight area 23, respectively. By passing the light from one of the backlight areas through the corresponding colored block (bar), the color of light can be purified or converted into a different color.

As shown in FIG. 3E, the backlight module 20E of the display device 1F has the backlight sources emitting the same color (such as several white light emitting diodes 2001). The color filter layer of the display device 1E includes several first colored blocks (bars) 1001, second colored blocks (bars) 1002 and third colored blocks (bars) 1003, wherein the first colored blocks 1001, the second colored blocks 1002 and the third colored blocks 1003 are disposed correspondingly to the first light-emitting area 100, the second light-emitting area 200 and the third light-emitting area 300, respectively. The light emitted from the backlight module 20E pass through the different colored blocks, so that the first light-emitting area 100, the second light-emitting area 200 and the third light-emitting area 300 provide light of different colors.

As shown in FIG. 3F, the backlight module 20F of the display device 1F includes several independently controlled RGB LED backlight sources 2002. The color filter layer of the display device 1F includes several first colored blocks (bars) 1001, second colored blocks (bars) 1002 and third colored blocks (bars) 1003. By passing the light from the RGB LED backlight sources 2002 of the backlight module 20E through the corresponding colored blocks (bars), the color of the light can be purified or converted into a different color.

As shown in FIG. 3G, the backlight module 20G of the display device 1G can be designed to provide several backlight areas for emitting light of different colors. The color filter layer of the display device 1G may include several first colored sub-blocks (sub-bars) 101, second colored sub-blocks (sub-bars) 102 and third colored sub-blocks (sub-bars) 103, wherein one of the first colored sub-blocks 101, one of the second colored sub-blocks 102 and one of the third colored sub-blocks 103 are disposed correspondingly to three sub-pixels of one pixel in a light-emitting area. For example, one of the first colored sub-blocks 101, one of the second colored sub-blocks 102 and one of the third colored sub-blocks 103 are corresponding to three sub-pixels of one pixel in the first light-emitting area 100. By passing the light from one of the backlight areas (such as the first backlight area 21) through the corresponding colored sub-blocks, the color of light can be purified or converted into a different color.

As shown in FIG. 3H, the backlight module 20H of the display device 1H has the backlight sources emitting the same color (such as several white light emitting diodes 2001). The color filter layer of the display device 1H includes several first colored sub-blocks 101, second colored sub-blocks 102 and third colored sub-blocks 103, wherein one of the first colored sub-blocks 101, one of the second colored sub-blocks 102 and one of the third colored sub-blocks 103 are corresponding to three sub-pixels of one pixel in a light-emitting area. The lights emitted from the backlight module 20H pass through the colored sub-blocks. Accordingly, the display device 1H is capable of showing images with more delicate colors and versatile patterns in accordance with the arrangement of the colored sub-blocks.

As shown in FIG. 3I, the backlight module 20I of the display device 1I includes several independently controlled RGB LED backlight sources 2002. The color filter layer of the display device 1I includes several first colored sub-blocks 101, second colored sub-blocks 102 and third colored sub-blocks 103, wherein one of the first colored sub-blocks 101, one of the second colored sub-blocks 102 and one of the third colored sub-blocks 103 are corresponding to three sub-pixels of one pixel in a light-emitting area. The light emitted from the RGB LED backlight sources 2002 of the backlight module 20I passes through the corresponding colored sub-blocks. Accordingly, the display device 1I is capable of showing images with more delicate colors and versatile patterns in accordance with the arrangement of the colored sub-blocks.

The types and display characteristics of the embodied display devices of FIG. 3A to FIG. 3I as described above are listed in Table 1 and Table 2.

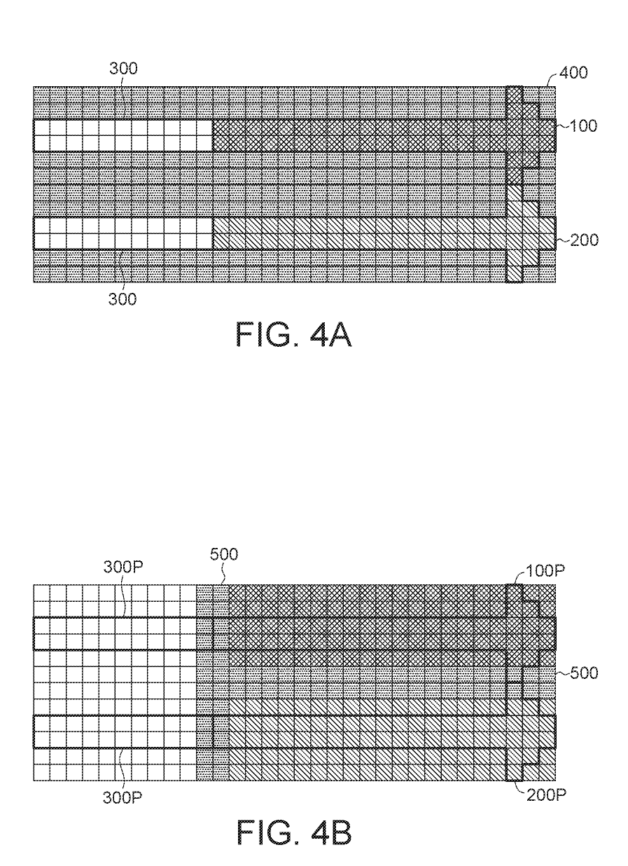

In Table 1, “Bar” represents a backlight module having several backlight areas, “W” represents a backlight module including white light emitting diodes, “RGB” represents a backlight module including RGB light emitting diodes, “N/A” represents that no color filter layer is included in the display panel, “CF Bar” represents the color filter layer of the display panel having several colored blocks of different colors, “CF RGB” represents the color filter layer having three different colors corresponding to three sub-pixels, “X” represents that the hue/pattern of the display image on the display device cannot be adjusted optionally, “Δ” represents that the hue/pattern of the display image on the display device can be adjusted to a certain extent, “∘” represents that the hue/pattern of the display image on the display device can be adjusted optionally, “ ̆” represents that an opaque region is preferably disposed (please see the descriptions related to FIG. 4A-FIG. 4B), “(optional)” represents that an opaque region can be selectively disposed or not disposed, and “X3” represents that the 3D resolution of the display device indicated by “X3” is three times of the 3D resolution of the display device indicated by “X1”.

TABLE 1

| | Backlight | Display | Hue/ | Opaque | 3D |
|---|---|---|---|---|---|
| | module | panel | Pattern | region | resolution |
| FIG. 3A | Bar | N/A | X | ̆ | X3 |
| FIG. 3B | W | N/A | X | ̆ | X3 |
| FIG. 3C | RGB | N/A | ◯ | ̆ | X3 |
| FIG. 3D | Bar | CF Bar | X | (optional) | X3 |
| FIG. 3E | W | CF Bar | X | (optional) | X3 |
| FIG. 3F | RGB | CF Bar | Δ | (optional) | X3 |
| FIG. 3G | Bar | CF RGB | Δ | (optional) | X1 |
| FIG. 3H | W | CF RGB | ◯ | (optional) | X1 |
| FIG. 3I | RGB | CF RGB | ◯ | (optional) | X1 |

In Table 2, “power of white light” (ratio) indicates a normalized power of the display device that exhibits white light emission. “Power of color light” (ratio) indicates a normalized power of the display device that exhibits non-white light emission, and “brightness conversion rate” indicates the ratio of the light emitting brightness of the display device divided by the brightness of light emitted from the backlight module. For example, if the brightness of light emitted from the backlight module is 10000 nits, the light emitting brightness of the display device having 5% of brightness conversion rate is 10000 nits×5%=500 nits.

TABLE 2

| | | | Power of | Power of | |
|---|---|---|---|---|---|
| | Backlight | Display | white light | color light | Brightness |
| | module | panel | (ratio) | (ratio) | conversion rate |
| FIG. 3A | Bar | N/A | X | 1.00 | 10.8% |
| FIG. 3B | W | N/A | 0.60 | X | 18% |
| FIG. 3C | RGB | N/A | 1.00 | 1.00 | 10.8% |
| FIG. 3D | Bar | CF Bar | X | 1.20 | 9% |
| FIG. 3E | W | CF Bar | X | 0.72 | 15% |
| FIG. 3F | RGB | CF Bar | X | 1.20 | 9% |
| FIG. 3G | Bar | CF RGB | X | 3.60 | 3% |
| FIG. 3H | W | CF RGB | 2.16 | 2.16 | 5% |
| FIG. 3I | RGB | CF RGB | 3.60 | 3.60 | 3% |

As indicated in Table 1 and Table 2, in the embodiments of the display devices as shown in FIG. 3C, FIG. 3F and FIG. 3I, the RGB LED backlight sources are disposed in the display devices containing no color filter layer, a color filter layer having several colored blocks of different colors, and a RGB color filter layer, respectively. At least two of sub-pixels in a single light-emitting area (e.g. the first light-emitting area 100) emit light having substantially the same color. The RGB color filter layer as shown in FIG. 3I allows merely one-third of a single color light to pass through a pixel, and the colored blocks of the color filter layer as shown in FIG. 3F allows a single color light to pass through a pixel entirely; accordingly, the light conversion efficiency of the single color light can be increased from 3% to 9%. If there is no color filter layer disposed in the display device, the light absorption by the color filter layer can be further reduced; thus, the light conversion efficiency can be increased from 9% of FIG. 3F to 10.8% of FIG. 3C. Thus, the results have clearly indicated that the displacement of the color filter layer and the arrangement of colored blocks have effects on the brightness conversion rate of the backlight from the backlight module.

As indicated in Table 1 and Table 2, in the embodiments of the display devices as shown in FIG. 3B, FIG. 3E and FIG. 3H, several white light emitting diodes as the backlight sources are disposed in the display devices containing no color filter layer, a color filter layer having several colored blocks of different colors, and a RGB color filter layer, respectively. At least two of sub-pixels in a single light-emitting area (e.g. the first light-emitting area 100) emit light having substantially the same color. Light conversion efficiency of the single color light is increased from 5% of FIG. 3H to 15% of FIG. 3E, and further increased to 18% of FIG. 3B. Also, the brightness conversion rates of the single color light of the embodied display devices in FIG. 3B, FIG. 3E and FIG. 3H are 1.66 times of the brightness conversion rates of the single color light of the embodied display devices in FIG. 3C, FIG. 3F and FIG. 3I, respectively. This is because the power required for the white LED backlight sources is lower than the power required for the RGB LED backlight sources. Thus, the results have clearly indicated that the types of the backlight sources and the design of backlight areas have effects on the brightness conversion rate of the backlight from the backlight module.

In some embodiments, the display devices of the disclosure can be applied to the image projectors of augmented reality head-up display (AR-HUD) for cars or other outdoor displays. The display brightness of a typical computer or mobile phone is about 500 nits; however, the display brightness of an image projector of AR-HUD for cars is about 12000 nits. According to the design of the embodiments, at least two of sub-pixels in a single light-emitting area (e.g. the first light-emitting area 100) emit light having substantially the same color, so that the light conversion efficiency of the single color light can be increased from 3% to 9%, even to 10.8%; accordingly, the initial brightness of the backlight module can be reduced by 3 to 3.6 times, such as from 400000 (12000/0.03) nits reduced to 111111 nits (12000/0.108). That is, about 73% of the initial brightness of the backlight module can be reduced, and about 73% of power consumption of the backlight module can be saved. Therefore, the display device of the disclosure applied to the image projector of AR-HUD for car has the advantage of saving power consumption.

As indicated in Table 1 and Table 2, in the embodiments of the display devices as shown in FIG. 3A, FIG. 3D and FIG. 3G, the backlight module having several backlight areas are disposed in the display devices respectively containing no color filter layer, a color filter layer having several colored blocks of different colors, and a RGB color filter layer, wherein the light conversion efficiency of the single color light is increased from 3% of FIG. 3G to 9% of FIG. 3D, and further increased to 10.8% of FIG. 3A.

In Table 1 and Table 2, as indicated by the results of the embodied display devices as shown in FIG. 3A, FIG. 3B and FIG. 3C, the embodied display devices of FIG. 3A and FIG. 3B contain no color filter layer, wherein the hue/pattern of the display image is determined in accordance with the design of the colors and areas of the backlight sources of the backlight module. However, the backlight modules of the display devices as shown in FIG. 3A, FIG. 3B and FIG. 3C have relative high brightness conversion rates, which possesses the advantage of saving power consumption.

The results of Table 1 and Table 2 also indicate that the brightness conversion rate of the display devices in FIG. 3D, FIG. 3E and FIG. 3F containing color filter layers are lower than the brightness conversion rate of the display devices in FIG. 3A, FIG. 3B and FIG. 3C. However, the display image with great hue and pattern can be displayed by adequately arranging the colored blocks and the types of the backlight sources in accordance with the colors and patterns of predetermined display images.

FIG. 4A illustrates a predetermined display patter according to one embodiment of the disclosure. FIG. 4B illustrates an arrangement of the light-emitting areas and the opaque areas according to one embodiment of the disclosure. The identical and/or similar elements of the embodiments are designated with the same and/or similar reference numerals. Also, the details of the identical or similar elements have been described above, and those contents are not redundantly repeated.

As shown in FIG. 4A, in one embodiment, a predetermined display pattern has a first light-emitting area 100 showing green color, a second light-emitting area 200 showing blue color, a third light-emitting area 300 showing yellow color, and a dark area 400 showing black color. One of the light-emitting areas includes several pixels, and the first light-emitting area 100 and the second light-emitting area 200 are configured as T-shape approximately. In some of the embodiments, when the light is emitted from the backlight module 20 and passes through the diffusion film, the light corresponding to one of the pixels is diffused and may be mixed with other light diffused by adjacent pixels, which leads to the mixture of the light colors or the blurring of pattern boundaries occurred in the borders of adjacent light-emitting areas, thereby obtaining the image with poor contrast.

According to some of the embodiments, the first light-emitting area 100 and the second light-emitting area 200 are separated by an opaque area 500, as shown in FIG. 4B. In other words, the first light-emitting area 100 is not adjacent to the second light-emitting area 200 since the opaque area 500 is disposed between the first light-emitting area 100 and the second light-emitting area 200. For example, as shown in FIG. 4B, the first light-emitting area has a first light-emitting pattern 100P originally, and the second light-emitting area has a second light-emitting pattern 200P originally, wherein two pixels at the boundary between the first light emitting pattern 100P and the second light emitting pattern 200P are replaced by the light opaque area 500.

Further, as shown in FIG. 4B, the first light-emitting area 100 and the third light-emitting area 300 can also be separated from each other by the opaque region 500, and the second light-emitting area 200 and the third light-emitting area 300 can also be separated from each other by the opaque region 500. For example, as shown in FIG. 4B, the third light-emitting area has a third light-emitting pattern 300P originally, wherein four pixels at the boundary between the first light emitting pattern 100P and the third light-emitting pattern 300P are replaced by the light opaque area 500, and four pixels at the boundary between the second light emitting pattern 200P and the third light-emitting pattern 300P are also replaced by the light opaque area 500. Accordingly, the mixture of the light colors or the blurring of pattern boundaries occurred in the borders of adjacent light-emitting areas, which may produce the image with poor contrast, can be avoided.

In the embodiment, the opaque region 500 can be implemented by a light a light shielding layer or several sub-pixels in a dark state. In some of the embodiments, when the light emitting pattern has been determined as a fixed pattern, the opaque region 500 can be a light shielding layer (such as a black matrix) disposed in the display panel. In some other embodiments, when the light emitting pattern can be changed based on the requirement from the user, the e opaque region 500 can be the sub-pixels in the dark state which are formed by controlling the liquid crystals in the display panel.

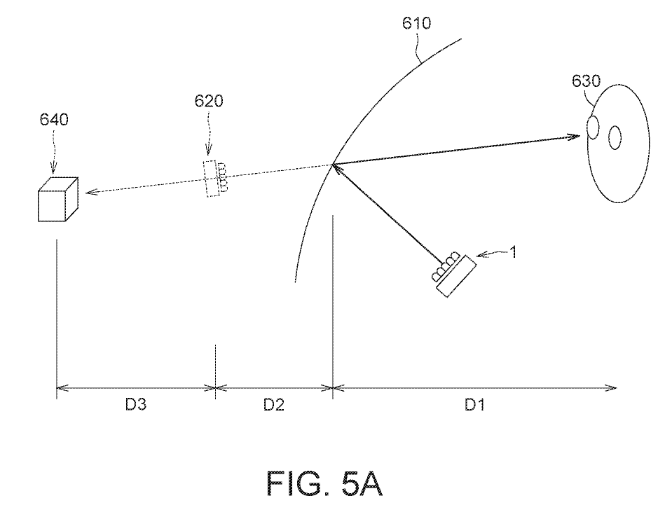

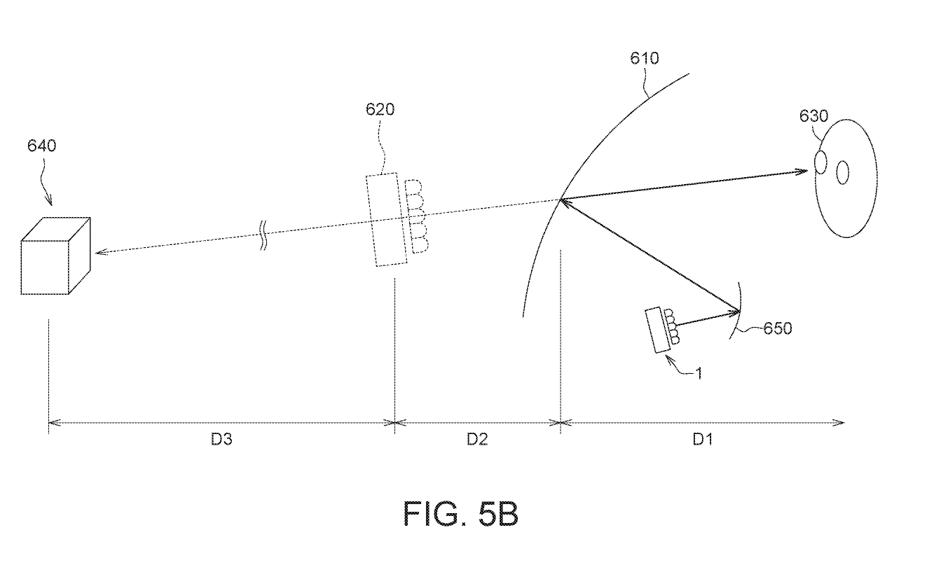

FIG. 5A is an illustration of a display device according to one embodiment of the disclosure applied to augmented reality. FIG. 5B is another illustration of a display device according to one embodiment of the disclosure applied to augmented reality. The identical and/or similar elements of the embodiments are designated with the same and/or similar reference numerals. Also, the details of the identical or similar elements have been described above, and those contents are not redundantly repeated.

As shown in FIG. 5A, when a display device of one embodiment of the disclosure is applied to an image projector of augmented reality head-up display (AR-HUD) for car, an image emitted by the display device 1 is refracted and reflected by a wind shield 610 to form a mirrored 3D image display 620, and further form a virtual image 640 perceived by the human eyes 630. The distance D1 between the human eyes 630 and the wind shield 610 is about 0.7 meters. The distance D2 between the wind shield 610 and the mirrored 3D image display 620 is about 0.3 meters. The distance D3 between the mirrored 3D image display 620 and is less than 1 meter.

As shown in FIG. 5B, when a display device of one embodiment of the disclosure is applied to an image projector of augmented reality head-up display (AR-HUD) for car, an enlarging projection optics 650 can be further disposed correspondingly to a displaying surface of the display device 1. An image emitted by the display device 1 is magnified by the enlarging projection optics 650, and then refracted and reflected by the wind shield 610 to form a mirrored 3D image display 620, and further form a virtual image 640 perceived by the human eyes 630. The distance D1 between the human eyes 630 and the wind shield 610 is about 0.7 meters. The distance D2 between the wind shield 610 and the mirrored 3D image display 620 is about 1.5 meters to 2 meters. By disposing the enlarging projection optics 650, the distance D3 between the virtual image 640 and the mirrored 3D image display 620 can be increased to approximately 30 meters.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, comprising:
a display panel having a first light-emitting area, wherein the first light-emitting area comprises a first sub-pixel and a second sub-pixel arranged adjacent to the first sub-pixel; and
a backlight module disposed opposite to the display panel, wherein the backlight module emits light, and the light has a first spectrum after passing through the first sub-pixel and has a second spectrum after passing through the second sub-pixel, wherein a peak of the first spectrum corresponds to a first wavelength, a peak of the second spectrum corresponds to a second wavelength, and a difference between the first wavelength and the second wavelength is less than 5 nm.

2. The display device according to claim 1, wherein the display panel comprises a color filter layer, and a color of a portion of the color filter layer corresponding to the first sub-pixel is substantially the same as a color of another portion of the color filter layer corresponding to the second sub-pixel.

3. The display device according to claim 1, wherein the backlight module comprises a first backlight source and a second backlight source, the first backlight source and the second backlight source are disposed correspondingly to the first light-emitting area, and the first backlight source and the second backlight source emit light of the same color.

4. The display device according to claim 1, further comprising:
an optical sheet disposed between the display panel and the backlight module, wherein the optical sheet comprises at least one of a brightness enhancement film, a reflective brightness enhancement film and a diffusion film.

5. The display device according to claim 1, wherein the backlight module comprises a plurality of backlight sources emitting white light.

6. The display device according to claim 1, wherein the backlight module comprises a first backlight area and a second backlight area, and the first backlight area and the second backlight area emit light of different colors.

7. The display device according to claim 6, wherein the backlight module further comprises a third backlight area, and colors of light emitted from the first backlight area, the second backlight area and the third backlight area are different.

8. The display device according to claim 7, wherein the backlight module further comprises a fourth backlight area, and a color of light emitted from the fourth backlight area is different from a color of light emitted from one of the first backlight area, the second backlight area and the third backlight area.

9. The display device according to claim 6, wherein no color filter layer is disposed in the display panel.

10. The display device according to claim 1, wherein the display panel further has a second light-emitting area, and the display panel comprises a color filter layer having a first colored block and a second colored block, wherein the first colored block is disposed correspondingly to the first light-emitting area, and the second colored block is disposed correspondingly to the second light-emitting area, and the first colored block and the second colored block have different colors.

11. The display device according to claim 1, wherein the display panel further has a second light-emitting area, the first light-emitting area and the second light-emitting area are separated from each other by an opaque region.

12. The display device according to claim 11, wherein the display panel further has a third light-emitting area, the first light-emitting area and the third light-emitting area are separated from each other by another opaque region.

13. The display device according to claim 11, wherein the opaque region is a light shielding layer or comprised of sub-pixels in a dark state.

14. The display device according to claim 1, further comprising:
a lenticular sheet, disposed on the display panel.

15. An electronic apparatus, comprising:
the display device of claim 1; and
an enlarging projection optics, disposed correspondingly to a displaying surface of the display device.

16. The electronic apparatus according to claim 15, wherein the display panel of the display device comprises a color filter layer, and a color of a portion of the color filter layer corresponding to the first sub-pixel is substantially the same as a color of another portion of the color filter layer corresponding to the second sub-pixel.

17. The electronic apparatus according to claim 15, wherein the backlight module of the display device comprises a first backlight source and a second backlight source, the first backlight source and the second backlight source are disposed correspondingly to the first light-emitting area, and the first backlight source and the second backlight source emit light of the same color.

18. The electronic apparatus according to claim 15, wherein the backlight module of the display device comprises a first backlight area and a second backlight area, and the first backlight area and the second backlight area emit light of different colors.

19. The electronic apparatus according to claim 18, wherein no color filter layer is disposed in the display panel of the display device.

20. The electronic apparatus according to claim 15, wherein the display panel of the display device further has a second light-emitting area, and the display panel comprises a color filter layer having a first colored block and a second colored block, wherein the first colored block is disposed correspondingly to the first light-emitting area, and the second colored block is disposed correspondingly to the second light-emitting area, and the first colored block and the second colored block have different colors.
